(19) United States
(12) Patent Application Publication
(10) Pub. No.: US 2013/0216314 A1
(43) Pub. Date: Aug. 22, 2013

(54) SYSTEMS AND METHODS FOR REEL LAYING SUBSEA PIPELINE TO REDUCE STRAIN IN USE

(71) Applicants: Antonio Carlos Falcao Critsinelis, Kingwood, TX (US); Sid Ahmed Mebarkia, Sugar Land, TX (US); Edward Shintaro Nakajima, Sugar Land, TX (US)

(72) Inventors: Antonio Carlos Falcao Critsinelis, Kingwood, TX (US); Sid Ahmed Mebarkia, Sugar Land, TX (US); Edward Shintaro Nakajima, Sugar Land, TX (US)

(73) Assignee: Chevron U.S.A. Inc., San Ramon, CA (US)

(21) Appl. No.: 13/400,480

(22) Filed: Feb. 20, 2012

(51) Int. Cl. F16L 1/12; B63B 35/03

(52) U.S. Cl. 405/168.3

(57) ABSTRACT

Disclosed are systems and methods for reel laying of subsea pipe in such a way that mitigates buckling and axial displacement of the pipe in use for conveying produced hydrocarbon fluids. The systems and methods include adjusting the settings of the pipe straightener and/or the pipe aligner during the reel laying process to provide non-straightened sections of pipe at predetermined locations along the length of the pipe. The non-straightened sections allow for thermal expansion of the pipe during use.

### BACKGROUND

The present disclosure relates to systems and methods for reducing strain during operation in subsea conduit such as offshore hydrocarbon production pipeline. The present disclosure further relates to providing sections of reeled pipe with higher residual reeling curvature as installed as a result of a modified straightening process.

Pipeline in offshore hydrocarbon production is installed on the seabed, often spanning great distances. Hydrocarbon well fluids carried by such pipelines can occur at high temperatures, e.g., greater than about 80° C., even up to about 165° C. Pipeline carrying such high temperature fluids can experience thermal gradients across the pipeline during multiple production shut downs and start ups resulting in expansion, contraction, and thermal cycling of the pipeline or conduit. This can result in pipeline buckling, movement, and loading that lead to both static peak and cyclic stresses, which may induce overstrain and fatigue failures along the length of the pipeline at locations which are relatively vulnerable and prone to these failure mechanisms.

These potential failure mechanisms can be mitigated by initiating controlled lateral buckling at locations along the pipeline which are determined analytically, such as by finite element analysis. Such mitigation measures reduce the lateral resistance of the pipeline so that the pipeline can deform or “buckle” in a smooth and controlled manner. In other words, the use of the mitigation measures facilitates the formation of an arc along the length of the pipeline in response to the stresses in the pipeline created by thermal gradients. This results in the development of smoother and more benign deformation, and therefore less strain and fatigue on the pipeline, than would occur without the use of the mitigation measures. For example, known mitigation measures include installation of buoyancy modules on the pipeline to reduce weight, introduction of vertical upsets along the length of the pipeline (using large diameter pipe sections referred to as “sleepers”) and installation of pipeline on the seabed in a “snake lay” formation.

These known solutions can increase cost, negatively impact installation schedules, and add complexity and risk to projects. It would be desirable to have an alternative, economical solution to control pipeline buckling resulting from thermal effects.

### SUMMARY

Disclosed are methods and systems for reel laying subsea pipe. One method includes unwinding pipe from a reel wound with pipe located on a vessel. While unwinding the pipe, the pipe is engaged with a pipe straightener comprising three bending supports in contact with the pipe to remove residual curvature in the pipe. The pipe straightener has one or more adjustable settings selected from relative spacing of the bending supports, relative position of the bending supports and amount of pressure applied by the bending supports to the pipe. One or more of the settings are adjusted over predetermined lengths at predetermined locations along the length of the pipe resulting in non-straightened sections of pipe having increased residual curvature provided along the length of the pipe.

Another method includes engaging the pipe with a pipe aligner having an adjustable radius and the pipe straightener to remove residual curvature in the pipe while unwinding the pipe. The radius of the pipe aligner is adjusted over predetermined lengths at predetermined locations along the length of the pipe resulting in non-straightened sections of pipe having increased residual curvature provided along the length of the pipe.

### DESCRIPTION OF THE DRAWINGS

These and other objects, features and advantages of the present disclosure will become better understood with regard to the following description, appended claims and accompanying drawings where:

FIG. 1 is a side view of a reel laying system according to one embodiment.

FIG. 2 is an illustration of subsea pipe laid on the seabed according to one embodiment.

### DETAILED DESCRIPTION

The present disclosure provides modified reel laying systems and methods to install subsea pipe, by which is meant a pipe or conduit that is located on a seabed. The terms “conduit,” “pipeline” and “pipe” are used herein interchangeably.

As is known in conventional reel laying systems and methods, pipe intended for use as subsea hydrocarbon production pipeline is pre-fabricated in long stalks and spooled onto a reel at an onshore location and then loaded onto a pipe laying vessel. At an appropriate offshore location, the pipe is unwound from the reel, also referred to as “spooling off” As the pipe is unwound from the reel, it passes, in sequence, through a pipe aligner, a pipe straightener and a pipe tensioner. The pipe is fully straightened within the conventional tolerances just before deployment. The purpose of the straightener is to remove residual curvature in the pipe after having been wound on the reel. Pipe straighteners generally utilize multiple tracks or rollers which engage the pipe with sufficient force to provide bending in a direction counter to the direction of residual curvature in the pipe, also referred to as “reverse bending.”

According to the present disclosure, conventional reel laying systems and methods are modified by intentionally disengaging or modifying the settings of the pipe straightener for a sufficient period of time to result in a non-straightened section of pipe in at least one predetermined location along the length of the pipe. As a result of not being subjected to straightening, the non-straightened section of pipe will retain residual curvature which would exceed conventional standards. As a result of the residual curvature, the non-straightened section of pipe can generally have an at least partially helical shape. If determined to be appropriate, the pipe straightener can be periodically disengaged at predetermined locations. In other words, it can be alternately engaged and disengaged, to result in multiple non-straightened sections along the length of the pipe. Such predetermined locations can be determined by the analytical methods, such as by finite element analysis. Alternatively, if determined to be appropriate, the entire length of the pipe can be non-straightened.

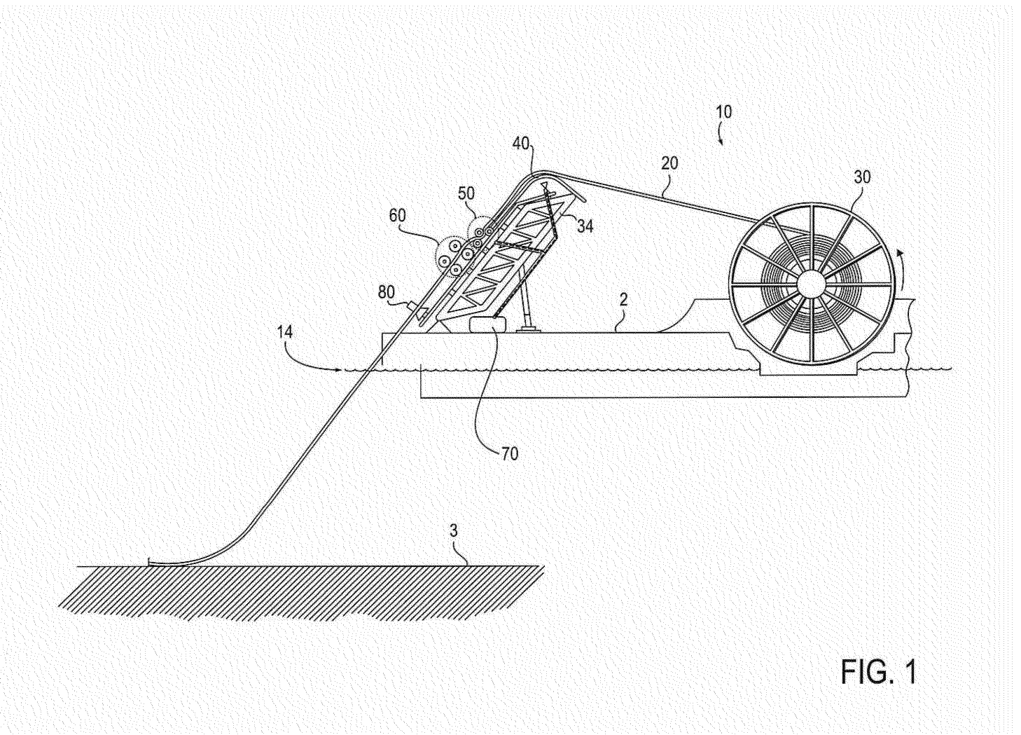

FIG. 1 is a side view of a reel laying system 10 mounted on a floating pipe laying vessel 2. Pipe 20, having been previously fabricated onshore, is wound on a reel 30 and mounted on vessel 2. As the pipe 20 is installed or laid onto the seabed 3, as in conventional practice, after being unwound from the reel 30, the pipe 20 passes through a pipe aligner 40, followed by a pipe straightener 50, a pipe tensioner 60 and a hang off clamp 80 before entering the water 14. The pipe laying equipment, i.e., the aligner 40, straightener 50, tensioner 60 and hang off clamp 80, are supported by ramp 34 mounted on the deck of vessel 2. The pipe straightener 50 can take the form of a series of rollers or tracks which are capable of applying force to the pipe 20 in a three-point configuration to create reverse bending in order to remove residual curvature from the pipe 20. In other words, the rollers or tracks of the straightener contact the pipe at three points, two on one side and one on the opposite side, in order to impart reverse bending.

According to the present disclosure, the straightener 50 has one or more settings which can be adjusted. These settings include the relative positions of the rollers or tracks, the spacing of the rollers or tracks, and the amount of pressure to be applied by each of the rollers or tracks to the pipe 20 at the points of contact with the pipe. Conventionally, these settings are determined onshore during unwinding of the pipe 20 from the reel 30 mounted onto the vessel 2. In the presently disclosed methods and systems, non-straightened sections of pipe can be provided over predetermined lengths at predetermined locations by adjusting the settings of the pipe straightener 50. For instance, the pressure applied by each of the rollers or tracks of the straightener can be reduced in a way that results in greater residual curvature in the pipe and therefore non-straightened sections of pipe. Alternatively, the pressure applied by the rollers or tracks of the straightener can be eliminated by disengaging the rollers or tracks from the pipe completely over predetermined lengths at predetermined locations along the length of the pipe 20. Alternatively, the relative positions and/or spacing of the rollers or tracks can be modified in a way that results in non-straightened sections of pipe.

The pipe aligner 40 can take the form of a series of rollers, a conveyor belt or a wheel which supports and aligns the pipe 20 after being unwound from the reel 30 and guides the pipe 20 as it enters the straightener 50. In one embodiment, non-straightened sections of pipe can be provided over predetermined lengths at predetermined locations by modifying the radius of the aligner 40 during pipe laying operations. For instance, the modified radius of the aligner can result in greater residual curvature in the pipe 20.

A control system can be used to control the methods and systems of the present disclosure. For instance, a control system can be embodied in a control station 70 used to control the engagement and disengagement of the rollers or tracks of the pipe straightener 50, to modify the relative spacing and positions of the rollers or tracks of the pipe straightener 50, to control the amount of pressure applied by the rollers or tracks of the pipe straightener 50, and/or to control the radius of the pipe aligner 40. The control station 70 can include a programmable processor which can be programmed with the predetermined location and the predetermined length along the length of the pipe 20 at which to adjust the pipe straightener and/or pipe aligner settings, thus creating the non-straightened sections of pipe. Alternatively, the control station 70 can include manual controls by which an operator can adjust the pipe straightener and/or pipe aligner settings. The control station 70 can be connected to the pipe straightener 50 and/or the pipe aligner 40 by any suitable control line, e.g., hydraulic fluid control line. The control station 70 can be located on the vessel 2 in any convenient location as would be apparent to one skilled in the art.

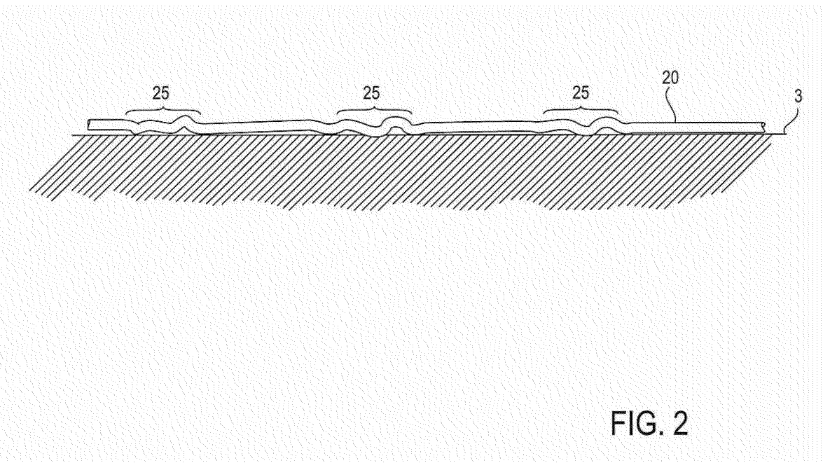

FIG. 2 is an illustration of a length of subsea pipe 20 having been reel laid from the vessel 2 onto the seabed 3, according to one embodiment. As can be seen, a number of non-straightened sections 25 have been provided in the pipe 20 at predetermined locations. The residual curvature in the pipe has been found to reduce the severity of potential lateral buckles resulting from thermal gradients during operation of the pipeline. The non-straightened sections of pipe 25 can be thought to be analogous to springs in the pipeline 20 which act as “buffers” to buckling since they can accommodate or absorb the pipeline motion resulting from thermal gradients during operation without shortening the pipeline to the degree that the pipeline would have been shortened without the non-straightened sections of pipe 25. Thus the non-straightened sections of pipe provide mitigation for uncontrolled, undesirable buckling. The methods and systems of the present disclosure have the advantages of being inexpensive and simple to implement, with no additional hardware required.

Unless otherwise specified, the recitation of a genus of elements, materials or other components, from which an individual component or mixture of components can be selected, is intended to include all possible sub-generic combinations of the listed components and mixtures thereof Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. A method for reel laying subsea pipe comprising:
a. unwinding pipe from a reel wound with pipe located on a vessel;
b. while unwinding the pipe, engaging the pipe with a pipe straightener comprising three bending supports in contact with the pipe to remove residual curvature in the pipe, wherein the pipe straightener has one or more adjustable settings selected from relative spacing of the bending supports, relative position of the bending supports and amount of pressure applied by the bending supports to the pipe; and
c. adjusting one or more of the settings of the pipe straightener over predetermined lengths at predetermined locations along the length of the pipe whereby non-straightened sections of pipe having increased residual curvature are provided along the length of the pipe.

2. A method for reel laying subsea pipe comprising:
a. unwinding pipe from a reel wound with pipe located on a vessel;
b. while unwinding the pipe, engaging the pipe with a pipe aligner having an adjustable radius and a pipe straightener to remove residual curvature in the pipe; and
c. adjusting the radius of the pipe aligner over predetermined lengths at predetermined locations along the length of the pipe such that non-straightened sections of pipe having increased residual curvature are provided along the length of the pipe.

3. A system for reel laying subsea pipe comprising:
a. a pipe straightener comprising three bending supports adapted to contact a pipe unwound from a reel to remove residual curvature in the pipe, wherein the pipe straightener has adjustable settings selected from relative spacing of the bending supports, relative position of the bending supports and amount of pressure applied by the bending supports to the pipe; and
b. a control mechanism for adjusting one or more of the settings of the pipe straightener over predetermined lengths at predetermined locations along the length of the pipe whereby non-straightened sections of pipe having increased residual curvature are provided along the length of the pipe.

4. A system for reel laying subsea pipe comprising:
a. a pipe aligner having an adjustable radius adapted to align a pipe unwound from a reel and guide the pipe to a pipe straightener comprising three bending supports adapted to contact a pipe unwound from a reel to remove residual curvature in the pipe; and
b. a control mechanism for adjusting the radius of the pipe aligner over predetermined lengths at predetermined locations along the length of the pipe whereby non-straightened sections of pipe having increased residual curvature are provided along the length of the pipe.

5. The system of claim 4 or 5, further comprising a vessel on which the system is mounted.
